(19) United States
(12) Patent Application Publication
(10) Pub. No.: US 2011/0212270 A1
(43) Pub. Date: Sep. 1, 2011

(54) MAGNETIC RECORDING MEDIUM MANUFACTURING METHOD

(75) Inventor: Shinji UCHIDA, Kawasaki-shi (JP)

(73) Assignee: Fuji Electric Device Technology Co., Ltd., Tokyo (JP)

(21) Appl. No.: 12/873,249

(22) Filed: Aug. 31, 2010

(30) Foreign Application Priority Data
Feb. 26, 2010 (JP) PA 2010-041807

(51) Int. Cl. C08J 7/04; G11B 5/68

(52) U.S. Cl. 427/510; 427/129

(57) ABSTRACT

A method of manufacturing a magnetic recording medium. The method includes altering magnetic characteristics of a magnetic recording layer at positions corresponding to concave portions of a mask layer by ion implantation or exposure to an activated halogen-containing reactive gas, via a mask layer on which a concavo-convex pattern is formed. The concavo-convex pattern is formed by forming a separating portion that magnetically separates magnetic portions of the magnetic recording layer in positions corresponding to convex portions of the mask layer. A resist material configuring the mask layer allows the shape of the concavo-convex pattern to vary after the formation of the concavo-convex pattern. A taper angle of a stepped portion marking the boundaries between the concave and convention portions of the concavo-convex pattern, when starting the alteration of magnetic characteristics of the magnetic recording layer, is between 66° and 88°.

### BACKGROUND OF THE INVENTION

1. Field of the Invention

The present invention relates to a magnetic recording medium manufacturing method preferable as a discrete track medium, or patterned medium such as a bit-patterned medium, having good electromagnetic conversion characteristics even at a high recording density.

2. Related Art

A magnetic recording device is one type of information recording device that has supported an advanced information society in recent years. As the volume of information increases, an improvement in the recording density of a magnetic recording medium used in a magnetic recording device is required. In order to realize high recording density, a unit of magnetization reversal (a recording unit) must be made smaller. To this end, it is important that the sizes of magnetic crystal grains be reduced, and at the same time that magnetic interactions between adjacent recording units are reduced by clearly separating and demarcating recording units.

As one technique for realizing a high density in magnetic recording, a perpendicular magnetic recording medium has been proposed in place of a longitudinal magnetic recording medium. Generally, a perpendicular magnetic recording medium has a structure wherein a soft magnetic layer, a crystal orientation control layer, a magnetic recording layer, and a protective layer are deposited in that order on a base. As the material for the magnetic recording layer of a perpendicular magnetic recording medium, at present, mainly CoCr system alloy crystalline films having a hexagonal close-packed structure (hcp structure) are being considered. When carrying out perpendicular magnetic recording, the crystal orientation of a material having an hcp structure is controlled so that its c axis is perpendicular to the plane of the film (that is, so that the c plane is parallel to the film plane). Also, in order to accommodate a further increase in the recording density of a magnetic recording medium in future, efforts are being made to reduce the sizes of the crystal grains configuring the CoCr system alloy crystalline film, reduce the particle diameter distribution, reduce magnetic interactions between particles, and the like.

Furthermore, as one method of controlling the magnetic layer structure in order to raise the density, a method has been proposed which uses a magnetic layer (generally called a granular magnetic layer) having a structure in which magnetic crystal grains are surrounded by a non-magnetic non-metal substance such as an oxide or nitride.

For example, it has been reported that by means of a high frequency sputtering using a CoNiPt target to which an oxide such as SiO₂ has been added, it is possible to form a granular magnetic layer having a structure in which individual magnetic crystal grains are surrounded by a non-magnetic oxide and individually separated, and noise reduction is realized (refer to U.S. Pat. No. 5,679,473).

In this kind of granular magnetic layer, the grain boundary phase of a non-magnetic non-metal (a non-magnetic oxide) physically separates magnetic crystal grains, reducing the magnetic interaction between the magnetic crystal grains. This reduction in magnetic interaction suppresses the formation of zigzag domain walls occurring in transition regions of recording units, realizing low-noise characteristics.

Comparatively good magnetic characteristics and electromagnetic conversion characteristics are obtained with a perpendicular magnetic recording medium of the heretofore known technology using the heretofore described kind of granular magnetic layer. However, a granular magnetic layer used in the perpendicular magnetic recording medium of the heretofore known technology is a continuous film (also called a full-coverage film) having a uniform structure overall.

In order to further raise the recording density, the following must be achieved:

(1) Prevention of write bleeding into adjacent tracks, (2) reduction of the formation of zigzag domain walls due to random disposition of magnetic crystal grains, (3) reduction of the effect of thermal fluctuations due to downsizing crystal grains, and (4) reduction of magnetic interaction between magnetic crystal grains.

As means of achieving the above goals, it has been proposed that the units of magnetization reversal (recording units) be clearly demarcated. As one such means, a patterned medium has been proposed. As the patterned medium, a discrete track medium and a bit-patterned medium have been proposed.

In a discrete track medium, magnetically separated magnetic strips are fabricated, and the magnetic strips are used as tracks for carrying out magnetic recording. That is, boundaries between adjacent tracks are formed artificially. A discrete track medium is effective for the above-described 1. prevention of write bleeding into adjacent tracks and 2. reduction of the formation of zigzag domain walls.

Also, in a bit-patterned medium, magnetically separated island-like magnetic dots are fabricated, and the magnetic dots are used as bits for carrying out magnetic recording. That is, boundaries are artificially formed not only between tracks, but also between adjacent bits. A bit-patterned medium is effective for the above-described 1. prevention of write bleeding into adjacent tracks, 2. reduction of the formation of zigzag domain walls due to random disposition of magnetic crystal grains, 3. reduction of the effect of thermal fluctuations due to downsizing crystal grains, and 4. reduction of magnetic interaction between magnetic crystal grains.

Various methods have been proposed in order to obtain these patterned media. For example, it has been proposed that gaps between tracks on which recording and reproduction are performed are formed by providing gap portions in the high permeability layer and magnetic layer in a magnetic recording medium having a high permeability layer and magnetic layer on a base (refer to JP-A-4-310621, and in particular FIG. 1).

By adopting this kind of structure, it is stated that intermixing of recordings across adjacent tracks during reproduction can be reliably avoided.

Also, a method has been proposed whereby a spiral-shape concave portion is formed by etching the disc-shape substrate surface before forming the constituent layers including the magnetic recording layer, and magnetic strips are made by filling this concave portion with a magnetic body (refer to JP-A-56-119934, and in particular FIG. 1).

Also, a method has been proposed whereby magnetically independent magnetic strips are made by removing one portion of a soft magnetic layer, filling the area from which the soft magnetic layer has been removed with a non-magnetic guard band, and forming a magnetic recording layer thereupon (refer to Japanese Patent No. 2,513,746, and in particular FIG. 1).

Also, a method has been proposed whereby a magnetic recording layer made from magnetically independent magnetic strips is formed by carrying out a patterning of a soft magnetic layer and crystal orientation control layer (refer to JP-A-2003-16622, in particular FIGS. 2 and 3).

With this method, after forming a soft magnetic layer and a crystal orientation control layer on a non-magnetic substrate, gap concave portions are formed in order to induce discrete action. Next, the gap concave portions are filled with a non-magnetic material, forming a non-magnetic layer. Furthermore, when forming a magnetic recording layer thereupon, magnetic strips having good magnetic characteristics are formed on the crystal orientation control layer, but a layer having good magnetic characteristics is not formed on the non-magnetic layer. By means of the above method, magnetically independent magnetic strips are formed, and these magnetic strips are used as data tracks in which recording and reproduction are carried out.

Furthermore, a method has been proposed whereby a soft magnetic layer, an intermediate layer, and a magnetic recording layer are formed on a substrate, a predetermined concavo-convex pattern is formed extending from the magnetic recording layer to partway through the intermediate layer, and the magnetic recording layer is divided into a large number of recording elements (refer to JP-A-2006-12285).

The following items are described as advantages of this configuration:
(1) By providing an concavo-convex pattern which penetrates the magnetic recording layer, crosstalk with adjacent tracks during recording and reproduction can be prevented, and (2) by forming the concavo-convex pattern to partway through the intermediate layer without affecting the soft magnetic layer, it is also possible to prevent a deterioration of recording and reproduction characteristics.

Also, a method has been proposed whereby, by forming a resist mask having a predetermined pattern of openings on a magnetic recording layer, then carrying out an ion implantation through the resist mask, the magnetic characteristics in the magnetic recording layer corresponding to the positions of the openings are altered, forming separation portions (refer to JP-A-2002-288813).

Furthermore, a method of manufacturing a discrete track medium and bit-patterned medium has been proposed whereby a mask having a predetermined pattern is provided on a magnetic recording layer, then a halogen-containing active gas or a reactive liquid is caused to act through the mask, rendering one portion of the magnetic recording layer non-ferromagnetic (refer to JP-A-2002-359138). Also, it has also been proposed to form a continuous film magnetic recording layer on a patterned magnetic recording layer formed using the heretofore described method.

As heretofore described, many of the discrete track medium and patterned medium manufacturing methods proposed to date depend on the intentional removal of one portion of a constituent layer of the magnetic recording medium, or on causing magnetic characteristics to be lost by magnetic alteration. Specifically, the magnetic recording layer, the substrate, the soft magnetic layer, or both the soft magnetic layer and a crystal orientation control layer, are used as constituent layers of which one portion is removed.

However, when one portion of the magnetic recording layer is removed, as in the methods described in JP-A-4-310621 and JP-A-2006-12285, the magnetic recording layer itself is directly etched, so that damage of the magnetic recording layer due to etching, and/or corrosion of the magnetic recording layer due to residual components of an etching gas or etching liquid, occur, and there are concerns that the magnetic characteristics of the magnetic recording layer may be degraded.

Also, with a method in which magnetic strips are made by providing spiral-shape grooves in the substrate, and filling the grooves with a magnetic body, as described in JP-A-56-119934, it is difficult to form a magnetic recording layer having good crystal orientation and perpendicular magnetic anisotropy in only the fine grooves, and good magnetic characteristics cannot be expected.

Also, with the method whereby the soft magnetic layer is removed by etching described in Japanese Patent No. 2513746, and with the method whereby the soft magnetic layer and crystal orientation control layer are removed as in JP-A-2003-16622, a flattening process is provided. This is because in the event that there are large concavities and convexities in the surface, the levitation stability of the magnetic head deteriorates. The flattening process is performed by, for example, filling concave portions formed by removing a predetermined constituent layer with a non-magnetic material, then polishing and smoothing the surface using chemical mechanical polishing (CMP), or the like.

However, it is difficult to uniformly fill minute and deep concave portions without gaps. Furthermore, in the case of minute and deep gaps, concavities and convexities in the surface after filling also increase in size due to the concavities and convexities before filling. For this reason, when smoothing the surface using CMP or the like too, it is difficult to smooth, or the amount of polishing increases, so there are concerns that the film thickness cannot be controlled.

Meanwhile, with the method of forming a separation portion in which magnetic characteristics are altered by ion implantation described in JP-A-2002-288813, as it does not involve the intentional removal of one portion of a constituent layer, no flattening process is necessary. However, research by the inventors has shown that when magnetic characteristics are altered by ion implantation, the implanted ions diffuse in a lateral direction according to the depth to which the ions are implanted. When ions are implanted to a depth of 10 nm, which is the film thickness of a normal magnetic recording layer, or more, the ions diffuse to a width of 5 nm or more. For this reason, there is a limit to the fineness, and as things stand this method is not preferable for fabricating intervals of 150 nm or less (separation portions of 50 nm or less), which are necessary for a patterned medium such as a discrete track medium.

Also, with the method described in JP-A-2002-359138 too, whereby a halogen-containing active gas or a reactive liquid is caused to act, rendering one portion of the magnetic recording layer non-ferromagnetic, it is found that the demagnetized region exhibits a spread in a lateral direction with respect to the mask opening portions.

A mask for a halogen-containing active gas exposure or ion implantation is formed directly by electron lithography, or formed by nano imprinting with a stamp using electron lithography. Forming fine grooves over the whole of the magnetic recording medium surface takes a considerable time with electron lithography. For this reason, taking into consideration the spread in the lateral direction of the one portion of the magnetic recording layer rendered non-ferromagnetic by the halogen-containing active gas, and the spread in the lateral direction during ion implantation, it is not preferable from the point of view of productivity to form extremely fine grooves in advance. This is particularly preferable for intervals of 150 nm or less (separation portions of 50 nm or less), which are necessary for a patterned medium such as a discrete track medium.

### SUMMARY OF THE INVENTION

The invention, having been devised bearing in mind these kinds of problem, has an object of providing a manufacturing method of a magnetic recording medium with superior productivity, which can be manufactured without causing the kind of deterioration of a ratio (duty) of a magnetic portion with respect to a separating portion due to a spread in a lateral direction of magnetic characteristic damage seen in patterned media proposed to date, and which can be manufactured by a simple method.

In order to achieve the heretofore described object, a method of manufacturing a magnetic recording medium includes forming a continuous magnetic recording layer on a non-magnetic substrate, and forming a mask layer by applying a resist material on the magnetic recording layer. The concave and convex portions are formed alternatingly in the mask layer, with step portions marking boundaries between them, each step portion with a taper angle between 66 degrees and 88 degrees. After the concave and convex portions are formed, magnetic characteristics of portions of the magnetic recording layer corresponding to the concave portions are altered either by ion implantation, or by exposure to an activated halogen-containing reactive gas, via the mask layer, so as to form a separating portion magnetically separating magnetic portions of the magnetic recording layer located at positions corresponding to the convex portions of the mask layer.

Herein, where the resist material is an organic spin-on-glass (SOG) resist including a siloxane resin, it is possible to make the taper angle between 66 degrees and 88 degrees, by allowing the resist material to settle for a period of time in the range of 10 minutes and 24 hours between said forming concave and convex portions and said altering. Also, where the resist material is an imprint resist including a thermoplastic resin, it is possible to make the taper angle between 66 degrees and 88 degrees, by allowing the resist material to settle for a period of time in the range of 10 minutes and 24 hours between said forming concave and convex portions and said altering.

Also, a method of manufacturing a magnetic recording medium includes forming a continuous magnetic recording layer on a non-magnetic substrate, and a mask layer by applying an ultraviolet-cured resist material on the magnetic recording layer. Then alternating mask concave and mask convex portions are formed in the mask layer, with step portions marking boundaries between the alternating mask concave and convex portions, each with a taper angle between 66 degrees and 88 degrees, by applying a crystal glass stamp, the stamp having alternating stamp concave and convex portions corresponding to the alternating mask concave and convex portions and having stamp step portions marking boundaries between the alternating step convex and concave portions, each with a taper angle between 66 degrees and 88 degrees. Next, the magnetic characteristics of portions of the magnetic recording layer corresponding to the mask concave portions are altered by ion implantation, or by exposure to an activated halogen-containing reactive gas, via the mask concave and convex portions, so as to form a separating portion magnetically separating magnetic portions of the magnetic recording layer in positions corresponding to the mask convex portions.

According to the invention, it is possible to reduce the kind of deterioration of duty, which is the ratio of magnetic and non-magnetic regions in a pattern from a master made by electronic lithography, seen in patterned media proposed to date. Also, the method of the invention is simple, and has superior productivity. This is because, it being possible to use a master made by electronic lithography as heretofore, there is no need to use the kind of advanced electronic lithography which causes productivity to deteriorate.

### BRIEF DESCRIPTION OF THE DRAWINGS

FIG. 1 is a sectional schematic view of a configuration example of a patterned magnetic recording medium manufactured using a manufacturing method of embodiments of the invention;

FIGS. 2A to 2F are process drawings showing the manufacturing method of the embodiments of the invention with sectional schematic views of the patterned magnetic recording medium;

FIGS. 3A to 3C are sectional schematic views of the patterned magnetic recording medium for illustrating the effectiveness of a taper angle of a stepped portion of a mask layer on which is formed an concavo-convex pattern of the invention, where FIG. 3A shows a case in which the taper angle is too large, FIG. 3B a case in which the taper angle is appropriate, and FIG. 3C a case in which the taper angle is too small; and

FIG. 4 is an illustrative view of a cross-sectional shape of the concavo-convex pattern of the invention.

### DETAILED DESCRIPTION OF THE INVENTION

Hereafter, a description will be given, referring to the drawings, of embodiments of the invention. In each drawing, the same reference numerals will be given to identical or similar portions, and a description will be omitted.

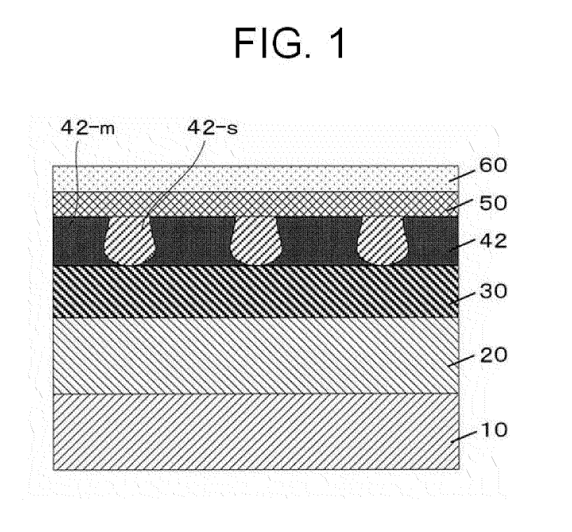

As shown in FIG. 1, a patterned magnetic recording medium manufactured using a manufacturing method of the embodiment of the invention is such that a soft magnetic under layer 20, an underlayer 30, a magnetic recording layer 42, a protective layer 50, and a lubrication layer 60 are formed sequentially on a non-magnetic substrate 10.

It is possible to fabricate the non-magnetic substrate 10 using an Al alloy, a reinforced glass, a crystallized glass, or the like, coated with an NiP plating used in a normal magnetic recording medium. Also, in the event that the substrate heating temperature is kept to 100° C. or less, it is also possible to use a plastic substrate made from a resin such as a polycarbonate or a polyolefin.

The soft magnetic under layer 20, being a layer which it is preferable to form in order to improve recording and reproduction characteristics by controlling magnetic flux from a magnetic head used in a magnetic recording, can also be omitted. As the material of the soft magnetic under layer 20, it is possible to use a crystalline FeTaC, a sendust (FeSiAl) alloy, or the like, or CoZrNb, CoTaZr, or the like, which are amorphous Co alloys.

Although the optimum value of the film thickness of the soft magnetic under layer 20 varies depending on the structure and characteristics of the magnetic head used in the recording, in the event that the film is formed consecutively with other layers, or the like, it is preferable from the point of view of balance with productivity that it is 10 nm or more, 500 nm or less. In the event of forming the film on the non-magnetic substrate in advance, using a plating method or the like, before forming the films of the other layers, it is also possible to make it thick at a few micrometers.

The underlayer 30 being a layer which it is preferable to form in order to control the crystal orientation, crystal grain diameter, and the like, of the magnetic recording layer 42 formed thereon, it is possible to use a non-magnetic material, or a soft magnetic material. It is also possible to omit the underlayer 30.

In the event that the underlayer 30 is of a soft magnetic material, the underlayer 30 performs one portion of the functions of the soft magnetic under layer 20, and is more preferably used. As the soft magnetic material, it is possible to use NiFeAl, NiFeSi, NiFeNb, NiFeB, NiFeNbB, NiFeMo, NiFeCr, or the like, which are a permalloy system of materials.

The film thickness of the permalloy system underlayer being adjusted so that the magnetic characteristics and electromagnetic conversion characteristics of the magnetic recording layer 42 are optimal, it is preferable from the point of view of balancing magnetic recording medium characteristics and productivity that it is roughly around 3 nm or more, 50 nm or less.

As a non-magnetic material, it is possible to use a material such as Ta, Zr, or Ni3Al. In the event of using a non-magnetic material, the thinner the film thickness the better from the point of view of effectively concentrating a magnetic field generated by the recording head in the soft magnetic under layer, so it is preferable that it is 0.2 nm or more, 10 nm or less.

Also, in order to optimally control the crystal orientation, crystal grain diameter, and intergranular segregation of the magnetic recording layer 42, it is also possible to form a non-magnetic intermediate layer in one portion of the underlayer. As the material thereof, it is preferable to use Ru, an an Ru based alloy wherein one type or more of a material selected from a group formed of C, Cu, W, Mo, Cr, Ir, Pt, Re, Rh, Ta, and V is added to Ru, or Pt, Ir, Re, Rh, or the like.

In order to realize a high density recording, it is necessary to make the film thickness of the non-magnetic intermediate layer as thin as possible within a range which does not cause the magnetic characteristics and electromagnetic conversion characteristics of the magnetic recording layer to deteriorate, and specifically, it is preferable to make it 1 nm or more, 20 nm or less.

Although there is no problem in the magnetic recording layer 42 being a single layer, it is preferable to configure it as multiple layers in order to enable a magnetization inversion. In particular, in a discrete track medium, it is preferable that the magnetic recording layer 42 is configured of multiple layers including at least one granular magnetic layer having a granular structure, and a non-granular magnetic layer having a non-granular structure. In the case of a bit patterned medium, there is no particular need for the magnetic recording layer 42 to be of a granular structure.

The magnetic recording layer 42 includes a ferromagnetic material. The ferromagnetic material includes a CoCr system alloy or CoPt system alloy. In particular, in order to obtain superior magnetic characteristics and recording and reproduction characteristics, it is preferable to use an alloy wherein at least one element from among Cr, Pt, Ni, Ta, and B is added to Co.

In the case of a granular material, it is preferable to use a material made from CoPt—SiO₂, CoCrPt—SiO₂, CoPt—SiO₂—TiO₂, CoCrPt—SiO₂—TiO₂, CoCrPt—SiO₂—Al₂O₃, CoPt—SiO₂—AlN, CoCrPt—SiO₂—Si₂N₄, or the like, wherein an intergranular material such as SiO₂ is added to an alloy material such as CoPt, CoCrPt, CoCrPtB, or CoCrPtTa.

The granular structure being a structure wherein magnetic crystal grains are dispersed in a matrix of non-magnetic oxides or non-magnetic nitrides, it is possible to suppress an interaction among magnetic crystal grains approximate in the magnetic recording layer.

It is preferable that the film thickness of the magnetic recording layer 42 is within a range of 5 nm or more, 50 nm or less. By having a film thickness within this range, it is possible to realize sufficient characteristics as a magnetic recording layer, and at the same time, it is possible to improve ease of magnetic recording and recording and reproduction resolution. Furthermore, from the points of view of productivity improvement and higher density recording, it is preferable that the magnetic recording layer has a film thickness of 10 nm or more, 25 nm or less.

Also, in the event of having multiple magnetic recording layers, and including a ferromagnetic joint between a first magnetic recording layer and a second magnetic recording layer, it is possible to suppress the interaction between the magnetic crystal grains in the magnetic recording layers, while maintaining the joint between the magnetic recording layers. As a result of this, as it is possible to improve noise, S/N characteristics, and the like, it is particularly preferable to use a granular structure as the first magnetic recording layer.

The protective layer 50 is a layer for protecting the magnetic recording layer 42 and the layers below it. It is possible to form the protective layer 50 using a material based on a material commonly used to date, for example, carbon (preferably, diamond-like carbon (DLC)).

It is preferable that the film thickness of the protective layer 50 is 1 nm or more, 10 nm or less. By having a film thickness within this kind of range, it is possible to prevent an occurrence of a pinhole, a reduction in durability, and a reduction in magnetic signal output due to a space between the magnetic head and the magnetic recording layer widening.

It is preferable that the lubrication layer 60 is additionally formed on the protective layer 50. The lubrication layer 60 can be formed using any material known to those skilled in the art, such as a perfluoro polyether system lubricant. As conditions such as the film thickness of the lubrication layer 60, it is possible to use the conditions used for a normal magnetic recording medium as they are.

Each of the layers stacked on the non-magnetic substrate 10 can be formed using various film forming techniques normally used in the field of magnetic recording media. It is possible to use, for example, a direct current (DC) magnetron sputtering method, a radio-frequency (RF) magnetron sputtering method, or a vacuum deposition method in the formation of each layer except the lubrication layer 60. Also, it is possible to use, for example, a dip-coating method or a spin-coating method in the formation of the lubrication layer 60.

The magnetic recording layer 42 is configured of multiple magnetic portions 42-m that carry out a recording and reproduction, and a separating portion 42-s that encloses the magnetic portions. Herein, the magnetic portions 42-m are portions that have the magnetic characteristics of the magnetic recording layer as it is deposited. Meanwhile, the separating portion 42-s is a portion that, altering magnetically due to exposure to an activated halogen-containing reactive gas, to be described hereafter, or due to an ion implantation, and not having good magnetic characteristics, magnetically divides the magnetic portions 42-m. Alternatively, the separating portion 42-s can also be formed by, after physically etching one portion in the depth direction of the magnetic recording layer, causing magnetic alteration using the heretofore described kinds of method.

It not being necessary that the separating portion 42-s is completely demagnetized, provided that it does not have the kind of magnetic characteristic that becomes a noise source, it is sufficient to make it a condition that a sufficient signal-to-noise (S/N) ratio can be maintained as a magnetic signal characteristic of the magnetic recording medium. From our experiments, when a coercivity Hc in the perpendicular direction is 6 kOe in the magnetic portions, it is sufficient that it is 1 kOe or less in the separating portion.

When the separating portion 42-s is caused to alter magnetically due to exposure to an activated halogen-containing reactive gas, or due to an ion implantation, even after the formation of the magnetic portions and separating portion, no concavity and convexity is formed in the surface thereof. Also, as it is an extremely slight concavity and convexity even in the event that it exists, it does not happen that a physical concavity and convexity that has an adverse effect on the levitation stability of the magnetic head is formed in the surfaces of the magnetic recording layer 42, protective layer 50, or lubrication layer 60 either. Alternatively, in the event of carrying out a magnetic alteration of the separating portion 42-s after physically etching one portion of the surface of the magnetic recording layer, the depth to which the magnetic alteration is to be carried out is reduced, and it is possible to prevent the magnetically altered portion from spreading to what should be the magnetic portions.

However, by physically etching one portion of the magnetic recording layer, an concavity and convexity is formed in the medium surface, and the head levitation becomes unstable. Furthermore, in the event that the physical etching is deep, a planarizing process such as an implantation also becomes necessary. For this reason, it is preferable that physically the etching depth is 10 nm or less. More preferably, it is 4 nm or less. Also, in a process of forming an concavo-convex portion in the magnetic recording layer, it is preferable to use a reactive gas containing any kind of inert gas, oxygen (O₂), or fluorine (F), as an etching gas.

In the event of forming a discrete track medium, the magnetic portions configure multiple concentric tracks in a recording track region and a servo pattern in a region in which a servo signal is recorded, and the separating portion configures a region sectionalizing the tracks and a region sectionalizing the servo pattern. In the region in which the servo signal is recorded, as signals are merely 0/1 signal reversals, the separating portion may configure a servo pattern, and the magnetic portions may configure regions sectionalizing servo patterns. Alternatively, in the event of forming a bit-patterned medium, the magnetic portions configure multiple recording units (including recording units for recording servo signals), and the separating portion configures regions sectionalizing recording units.

The disposition intervals of the magnetic portions depend on the magnetic recording medium configuration and recording density. For example, the interval between adjacent tracks in a discrete track medium with a recording density of 500 gigabits per square inch is required to be 70 nm or less. Alternatively, the interval between adjacent recording units in a bit-patterned medium with a recording density of one terabit per square inch is 25 nm.

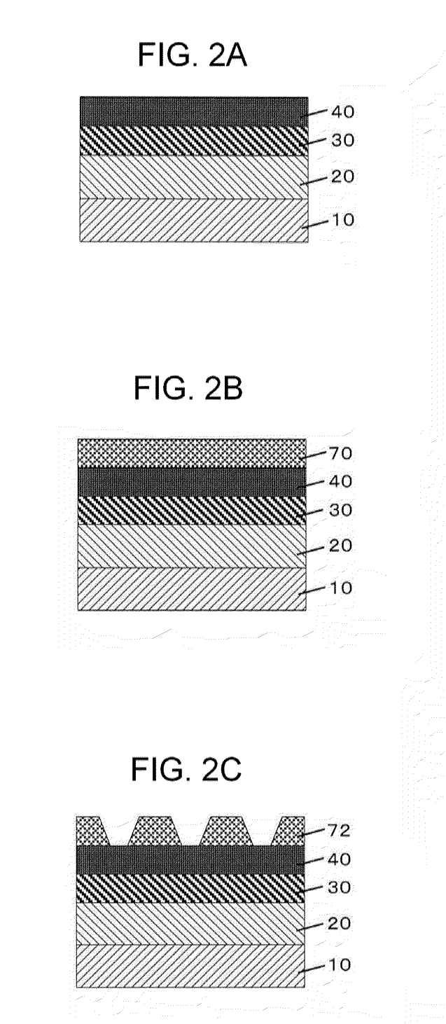

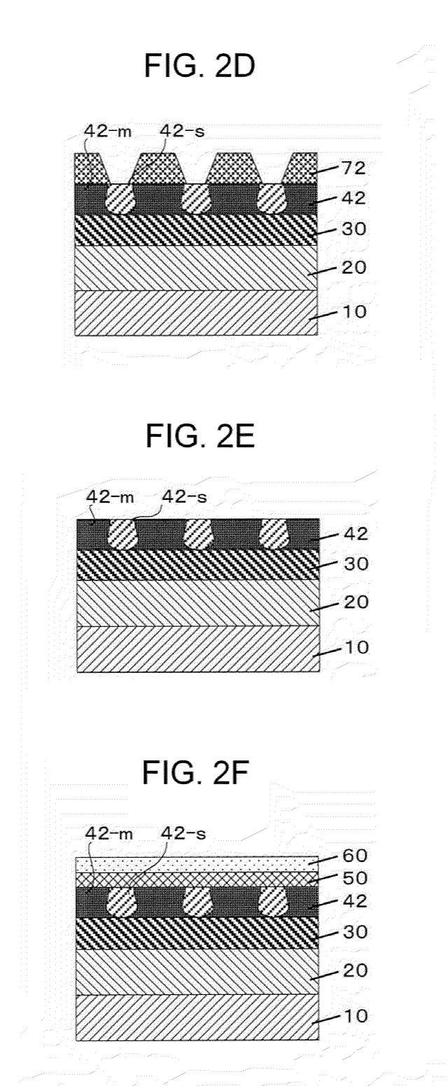

Next, referring to FIG. 2, a description will be given of a manufacturing method of the magnetic recording medium of the invention.

### Magnetic Recording Layer Formation Step

Firstly, as shown in FIG. 2A, the soft magnetic under layer 20, the underlayer 30, and the magnetic recording layer 40 are stacked on the non-magnetic substrate 10. The soft magnetic under layer 20, the underlayer 30, and the magnetic recording layer 40 can be fabricated using any method known to those skilled in the art, such as a sputtering method, or an electroless plating method. In this specification, the reference numeral “40” refers to the magnetic recording layer before the magnetic portions 42-m and the separating portion 42-s are formed.

### Mask Layer Formation Step

Next, as shown in FIG. 2B, a resist material is applied on the magnetic recording layer 40, forming a mask layer 70. Imprinting Step

Next, as shown in FIG. 2C, a patterning is carried out on the mask layer 70 made from the resist using a so-called nano imprinting method, wherein a stamp having an concavo-convex pattern is pressed, transferring the concavity and convexity of the stamp. In the specification, the reference numeral “70” refers to the mask layer before mask portions 72-L and non-mask portions 72-G are formed. “72” refers to the mask layer after the mask portions 72-L and the non-mask portions 72-G are formed. The pattern height of the mask layer 72 made from the resist can be optionally set by means of the resist application thickness, the stamp pattern height, the pressing pressure, and the like. Also, in the event that a resist residue is formed in a mask concave portion, it is possible to optionally control the residue amount by carrying out a dry etching, and it is also possible to eliminate the residue.

It being sufficient that the resist is of a material that can be patterned using the nano imprinting method, when patterning with a room temperature imprinting, it is possible to use an SOG resist (a resist made from an organic spin-on-glass including a siloxane resin). When patterning with a thermal imprinting, it is possible to use a resist of a thermoplastic resin system such as a PMMA resist (a resist including a polymethylmethacrylate resin). Also, when patterning with a photocure type of imprinting, it is possible to use an ultraviolet cured resist such as a novolac system resist, or an acrylic acid ester system resist.

Also, the pattern height of the mask layer 72 made from the resist needs to be a height which can protect the magnetic recording layer 40 underneath, taking into account resistance to exposure to the activated halogen-containing reactive gas or the depth of the ion implantation, and can be decided experimentally.

Also, in the event that the mask height is insufficient with respect to resistance to exposure to the reactive gas or the depth of the ion implantation, it is possible to form a hard mask, making the mask layer a two layer laminated configuration. For example, it is possible to form a mask layer 72 made from two layers, one each of carbon and SOG. With this method, firstly, a carbon film is formed on the magnetic recording layer as the hard mask, and on top of that, concavities and convexities that form the pattern are formed in a resist made from SOG (spin-on-glass) using a room temperature imprinting. Next, after removing remaining film of the SOG resist by means of a dry etching using CF₄ gas, it is possible to form the pattern in the carbon film with a dry etching using O₂ gas. By so doing, it is possible to form a mask layer 72 made from two layers, one each of carbon and SOG, with a high pattern height ratio with respect to the groove width.

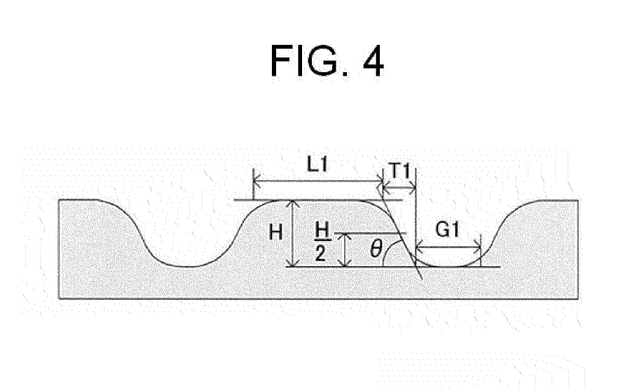

The shape of the concavo-convex pattern of the mask layer 72 (refer to FIG. 4) is measured in the following way based on an electron micrograph. That is, an angle of a wall surface with respect to the pattern head and bottom at a halfway point of a pattern height H is taken to be a taper angle θ, and intersection points extending from the pattern head to the bottom are taken to be a head width L1 and a groove width G1 respectively. T1 is taken to be the side wall width.

### Separating Portion Formation Step

Next, as shown in FIG. 2D, by exposing to the activated halogen containing reactive gas in the non-mask portions 72-G of the mask layer 72, the exposed portion of the magnetic recording layer 40 is magnetically altered, making it the separating portion 42-s. Also, the mask portions 72-L of the mask layer 72 are made the magnetic portions 42-m. A halogen containing reactive gas which can be used in this step is a gas containing halogen, including CF₄, CHF₃, CH₂F₂, C₃F₈, C₄F₈, SF₆, Cl₂, and the like. It being sufficient that the pressure of the halogen containing reactive gas in this step is within a range such that a radical reaction proceeds, it can be set at, for example, 0.1 to 3 Pa.

Activation of the halogen-containing reactive gas can, for example, be performed by means of a plasma generation mechanism used in reactive ion etching (RIE), or the like. The plasma generation mechanism used can be any mechanism known to those skilled in the art. In the invention, it is preferable that an inductive coupled plasma (ICP) method, which can generate high density plasma with a simple mechanism, is used. It is preferable that the power applied is set so as to be sufficient that the halogen-containing reactive gas undergoes a radical reaction, and also be such that physical etching of the surface of the exposed magnetic recording layer 40 does not occur. Although depending also on the exposure time, in general it is preferable that power in the range of 100 to 500 W, and more preferably 200 to 400 W, is applied to carry out activation. Also, in this step, a bias power may be applied. However, it is preferable that the bias power is 0 to 100 W, because physical etching of the exposed magnetic recording layer proceeds.

Also, as a method of magnetically altering the exposed portion of the magnetic recording layer 40, making it into the separating portion 42-s and separating it from the magnetic portions 42-m, via the mask layer 72, it is possible to use anion implantation method. An altering gas which can be used in this step is a gas containing N₂, He, O₂, or the like. It being sufficient that the pressure of the gas in this step is within a range such as to ionize efficiently, it can be set at, for example, 0.1 to 3 Pa.

Alteration by means of an ion implantation can be performed by means of an electron cyclotron resonance ((ECR) ion gun, or a plasma generation mechanism used in an inductive coupled plasma (ICP) method or the like. In the event of using an ECR ion gun, it is possible to carry out an ion implantation at an accelerating voltage of 1 to 3 keV, a current density of 1 to 2 mA/cm², and a microwave power of 100 to 200 W.

In the event of forming a hard mask too, provided that the main component of the hard mask is carbon, it can be supposed that there is no great difference in the mask's resistance to exposure to the reactive gas, or in ion screening ability with respect to the ion implantation.

### Mask Layer Removal Step

Next, as shown in FIG. 2E, the removal of the mask layer 72 is carried out. In the case of a resin system resist, the removal of the mask layer 72 can be performed by ashing in oxygen plasma, or by cleaning using a commercially available resist stripping liquid. In the case of an SOG system resist, it is possible to remove by means of a dry etching using CF₄ gas. Also, in the case of the heretofore described kind of two layer mask of carbon and SOG resist, the mask removal is possible by using a dry etching using CF₄ gas and a dry etching using oxygen gas in combination.

### Protective Layer and Lubrication Layer Formation Step

Finally, as shown in FIG. 2F, the protective layer 50 and the lubrication layer 60 are deposited on the magnetic recording layer 42, thus obtaining the magnetic recording medium. The formation of the protective layer 50 can be performed using any method known to those skilled in the art, such as a sputtering method or a chemical vapor deposition (CVD) method. Also, when forming a protective layer 50 made from DLC, a method such as a CVD method or a physical vapor deposition (PVD) method can be used. With regard to the formation of the lubrication layer 60, the lubrication layer 60 can be provided by applying the previously described liquid lubricant material on the protective layer 50, using a method known to those skilled in the art, such as a dip-coating or a spin-coating.

The layer configuration of the magnetic recording layer 40 in the magnetic recording medium of the invention is not limited to the configuration example of FIG. 1 and the fabrication process of FIGS. 2A to 2F. In the magnetic recording medium of the invention, a magnetic recording layer may be used which has another configuration satisfying the requirements that it includes at least one magnetic recording layer, that at least one of the magnetic recording layers includes multiple magnetic portions and a separating portion surrounding the magnetic portions, and that the separating portion has magnetic characteristics different from those of the magnetic portions.

### Embodiments

Hereafter, embodiments of the invention will be described. The following embodiments are merely examples for describing the invention appropriately, and in no way limit the scope of the invention. Also, although a discrete track medium is described in the embodiments, the invention can also be implemented using the same processes with a bit-patterned medium.

### Embodiment 1

As the substrate 10, a chemically reinforced glass substrate (an N-5 glass substrate, manufactured by Hoya Corp.) with a flat and smooth surface, an outer diameter of 65 mm, an inner diameter of 20 mm, and a thickness of 0.635 mm, is prepared. The soft magnetic under layer 20, with a film thickness of 200 nm, made from CoZrNb is formed on the substrate 10 using a sputtering method. Continuing, the underlayer 30 made from an NiFeNb film and an Ru film is formed. Furthermore, the magnetic recording layer 40 formed from layers of CoCrPt—SiO₂ and CoCrPt is deposited by means of a sputtering method using a CoCrPt—SiO₂ target and a CoCrPt target, thus obtaining the layered body shown in FIG. 2A.

Next, as shown in FIG. 2B, the mask layer 70 is formed. A two layer mask of carbon and an SOG resist is used for the mask layer 70. Firstly, 10 nm of diamond-like-carbon (DLC) is formed on the magnetic recording layer using a CVD method. After that, 50 nm of an SOG resist (organic spin-on-glass including a siloxane resin: Tokyo Ohka Kogyo Co., Ltd. OCNL-540) is formed on the DLC using a spin-coating method.

Next, as shown in FIG. 2C, the mask layer 72 is formed by patterning. That is, a pattern formed of concavities and convexities with a pattern height of 50 nm is formed in the surface of the SOG resist by a nano imprinting using an Ni stamp on the surface of the SOG resist. In order to do this, the patterned surface of the Ni stamp is superimposed on the SOG resist surface, they are set in a die set configured of parallel plates, and pressed together for 30 seconds at a pressure of 180 MPa using a hydraulic press. Subsequently, the stamp and substrate are detached, and the concavo-convex pattern of the stamp is transferred to the SOG resist surface.

The Ni stamp is fabricated by carrying out an Ni electrocasting using a master formed by EB lithography. EB lithography in data recording regions is performed so as to obtain a resist layer wherein lines of width 40 nm, in the shape of concentric circles, are arranged at intervals of 60 nm. Meanwhile, EB lithography is performed so that the resist layer remains in positions corresponding to burst islands in servo signal recording regions. Next, by carrying out an Ni electrocasting using the master fabricated in the way heretofore described, an Ni stamp is fabricated wherein the pattern in the data recording regions is such that lines of width 20 nm, in the shape of concentric circles, are arranged at intervals of 60 nm.

Next, the medium is disposed in an ICP-type high density plasma etching device, and the remaining SOG film is removed by means of a plasma etching using CF₄ gas. Furthermore, the carbon in the opening portions of the SOG is etched by means of a plasma etching using O₂ gas. By so doing, a mask layer 72 made from two layers, one each of carbon and an SOG resist, is fabricated.

The plasma etching using CF₄ gas is carried out with a bias power of 20 W at a flow rate of 10 sccm, a pressure of 0.1 Pa, and an antenna power of 200 W. Also, the plasma etching using O₂ gas is carried out with a bias power of 20 W at a flow rate of 10 sccm, a pressure of 0.1 Pa, and an antenna power of 100 W.

It is not necessary to completely remove the mask in the concave portions, but rather, it being sufficient that the ions in the ion implantation or the halogen in the halogen exposure can be transmitted, it is sufficient that it is removed to 0 to 10 nm depending on the ion implantation and halogen exposure conditions.

The fabrication of the taper angle of the opening portions or stepped portion of the patterned portion of the mask layer 72 is carried out while varying the time from the imprinting of the SOG resist until the high density plasma etching is carried out (settling time) between 1 minute and 72 hours. The concavo-convex shape of the mask layer 72 is evaluated with a cross-sectional scanning electron microscope (SEM). From a cross-sectional SEM photograph taken at a magnification of 100,000 times, the angle of the wall surface with respect to the pattern head portion at the halfway point of the pattern height His taken to be the taper angle θ (refer to FIG. 4). The results of evaluating the relationship between the settling time and the mask shape (the taper angle θ) are shown in Table 1.

TABLE 1

| Settling Time | | Taper Angle (°) |
|---|---|---|
| 1 | minute | 90 |
| 3 | minutes | 89 |
| 10 | minutes | 88 |
| 30 | minutes | 86 |
| 1 | hour | 83 |
| 3 | hours | 79 |
| 6 | hours | 75 |
| 12 | hours | 70 |
| 24 | hours | 66 |
| 48 | hours | 60 |
| 72 | hours | 55 |

Next, an alteration of the layered body forming the patterned mask layer is carried out by means of an ion implantation, as shown in FIG. 2D. This is carried out using an ECR ion gun at an accelerating voltage of 2 keV, a current density of 1.5 mA/cm², and a microwave power of 150 W. In this process, portions not covered by the mask layer 72 are magnetically altered, forming the separating portion 42-s. Portions covered by the mask layer 72 become the magnetic portions 42-m, which maintain the original magnetic characteristics, and the kind of magnetic recording layer 42 shown in FIG. 2D is obtained. As a design value of the magnetic portions 42-m in the data recording regions, the configuration is such that multiple tracks in the shape of concentric circles, having a width of 40 nm, are arranged at intervals of 60 nm.

Next, as shown in FIG. 2E, the removal of the mask layer 72 is carried out. For the removal of the mask layer 72, a high frequency power with a frequency of 13.56 MHz and an output of 200 W is applied in the ICP-type high-density plasma etching device, and firstly, the SOG resist is removed using a CF₄ gas with a flow rate of 30 sccm and a pressure of 1 Pa, after which, the carbon mask is removed by etching with oxygen plasma using an O₂ gas with a flow rate of 50 sccm and a pressure of 1 Pa. No bias power is applied to the layered body at this time. By means of the above process, it is possible to carry out the stripping of the mask layer 72 while minimizing damage to the magnetic portions 42-m.

Next, as shown in FIG. 2F, the protective layer 50, with a film thickness of 3 nm, made from carbon is formed using a sputtering method, and finally, perfluoro polyether is applied using a dip-coating method, forming the lubrication layer 60 with a film thickness of 2 nm, and the magnetic recording medium is obtained.

Physical concavities and convexities in the magnetic recording medium obtained as described above are evaluated using an atomic force microscope (AFM). As a result, the maximum size of the concavities and convexities in the surface arising from the pattern of the magnetic portions 42-m and separating portion 42-s is 0.5 nm. These concavities and convexities satisfy the criterion of 2 nm or less demanded of a magnetic recording medium from the point of view of head levitation stability, and the like. Furthermore, head levitation tests are carried out using a commercially available perpendicular magnetic recording head. Contact of the head with the medium when using the magnetic recording medium obtained is of the same extent as for a normal magnetic recording medium. From this, it is found that, despite the fact that a flattening process is not applied, the magnetic recording medium of the invention exhibits excellent head levitation stability.

Furthermore, the ratio (duty) between track signal characteristics and track gaps, and fringe tolerance, in the magnetic recording medium obtained are evaluated. The duty is measured from the proportion of signal regions and non-signal regions in a spin stand test. Also, for the fringe resistance, after measuring the bit error rate (BER) after carrying out a recording in a central track, 100,000 recordings are carried out in adjacent tracks, the BER of the central track is measured again, and the change ratio thereof is calculated. No change indicates a change ratio of 100%.

Results of an evaluation of the relationship between the shape (taper angle) of the mask layer 72 and the discrete track medium characteristics are shown in Table 2.

TABLE 2

| Taper | Duty | Fringe Test | |
|---|---|---|---|
| Angle (°) | (%) | Change Rate (%) | Determination |
| 90 | 61 | 80 | x |
| 89 | 63 | 90 | x |
| 88 | 66 | 100 (no change) | ∘ |
| 86 | 66 | 100 (no change) | ∘ |
| 83 | 66 | 100 (no change) | ∘ |
| 79 | 66 | 100 (no change) | ∘ |
| 75 | 66 | 100 (no change) | ∘ |
| 70 | 66 | 100 (no change) | ∘ |
| 66 | 66 | 100 (no change) | ∘ |
| 60 | 60 | 82 | x |
| 55 | 52 | 75 | x |

As a result of this, it is found that, when the taper angle of the opening portions or stepped portion of the patterned portion of the mask layer 72 is 66° or more, 88° or less, there is no deterioration of the duty or fringe resistance. Because of this, it is confirmed that, in the magnetic recording medium of the embodiment, adjacent tracks are magnetically separated.

Also, when looking at the time from the imprinting of the SOG resist surface until the high density plasma etching is carried out (the settling time), it is found that there is no deterioration of the duty or fringe resistance when the settling time is between 10 minutes and 24 hours.

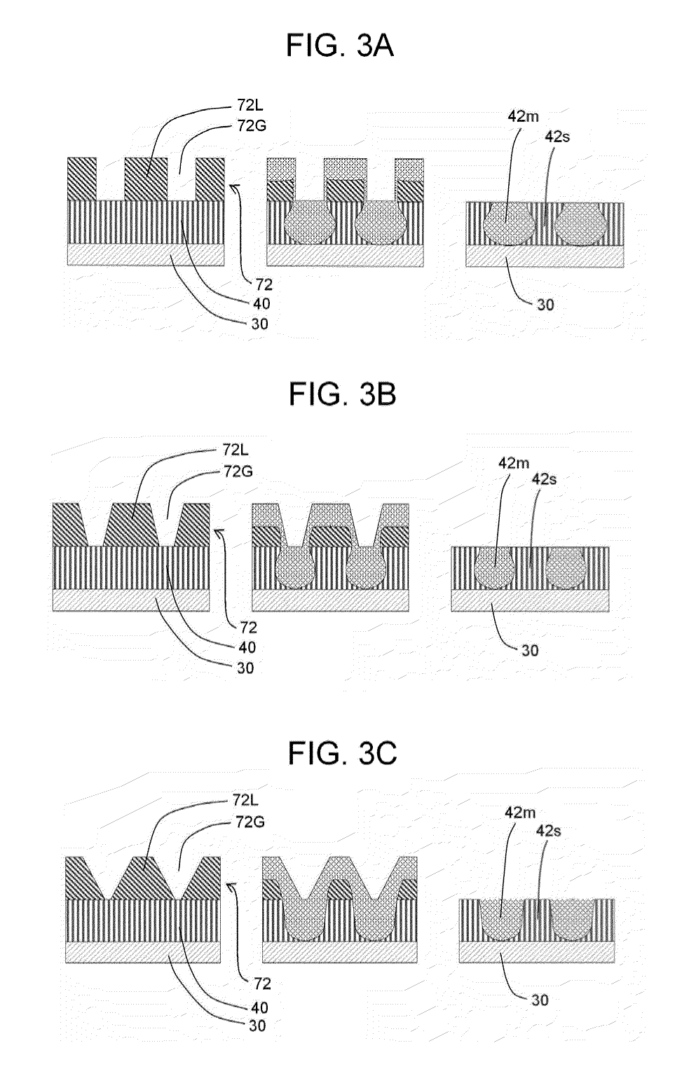

The reasons for this are considered to be as follows: In the event that the taper angle of the opening portions or stepped portion of the patterned portion of the mask layer 72 is too large, as in FIG. 3A, there is a spread of damage in a comparatively deep portion of the magnetic layer (magnetic recording layer) due to a spread in a lateral direction of ions implanted from the mask bottom portion, and the magnetic characteristics deteriorate. It is considered that for this reason the duty deteriorates, and the fringe characteristics deteriorate.

Conversely, in the event that the taper angle of the opening portions or stepped portion of the patterned portion of the mask layer 72 is too small, as in FIG. 3C, ions pass through a thin portion in the vicinity of the mask bottom portion edge, damage is inflicted on a comparatively shallow portion of the magnetic layer (in the vicinity of the surface), in a portion in which the magnetic characteristics should by rights remain, and the magnetic characteristics deteriorate. It is considered that for this reason the duty deteriorates, and the fringe characteristics deteriorate.

In the case of an optimum taper angle of the opening portions or stepped portion of the patterned portion of the mask, as in FIG. 3B, the transmission of the ions from the mask bottom portion edge and the spread of the ions in the lateral direction occur with a good balance, and damage to the magnetic layer in the depth direction of the magnetic recording layer is inflicted comparatively evenly. It is considered that for this reason the duty deterioration and fringe characteristic deterioration are small.

### Embodiment 2

Next, a description will be given of another embodiment of the invention. In this Embodiment 2 also, the layered body shown in FIG. 2A, with the same structure as that of Embodiment 1, is used.

Next, as shown in FIG. 2B, the mask layer 70 is formed. A two layer mask of carbon and a UV imprint resist is used for the mask layer 70. Firstly, 3 nm of diamond-like-carbon (DLC) is formed on the magnetic recording layer 40 using a CVD method. After that, 80 nm of a UV imprint resist (PAK-01 manufactured by Toyo Gosei) is formed on the DLC using a spin-coating method.

Next, as shown in FIG. 2C, a pattern is formed in the mask layer 70. Firstly, a pattern formed of concavities and convexities with a pattern height of 80 nm is formed in the surface of the UV resist by a UV nano imprinting using a crystal glass stamp. Actually, in a condition in which the patterned surface of the crystal glass stamp is superimposed on the UV resist surface, pressing is carried out for 30 seconds from the crystal glass stamp side at a pressure of 1 MPa, while irradiating with UV light, using a micropattern transfer device (ST-50 manufactured by Toshiba Machine). Subsequently, the stamp and substrate are detached, and the concavo-convex pattern of the stamp is transferred to the UV imprint resist surface. In order to obtain a desired mask cross-sectional shape, processing is done in advance in such a way that a few kinds of taper are created in the pattern of the crystal glass stamp.

A method of fabricating a crystal glass stamp processed in such a way that a taper is created in the pattern is shown hereafter. The crystal glass stamp is fabricated by carrying out a dry etching using a master formed by EB lithography. Firstly, a crystal substrate with a thickness of 1.0 mm, on which is formed a chrome thin film, is prepared. Next, an EB lithography resist (ZEP-520A manufactured by Zeon Corporation) is applied to a film thickness of 60 nm on the surface of the chrome thin film of the substrate, using a coater-developer device. Subsequently, the resist is lithographed using an EB device.

Next, using the coater-developer device, development is carried out with an EB resist developing fluid (for example, ZEP-RD manufactured by Zeon Corporation), and the patterning of the resist is carried out. The lithography of a data region and servo region is carried out in the patterning of the resist. The lithography of the data region is carried out in such a way that lines and groups are formed circumferentially at 150 nm intervals in each sector. The servo region is formed in such a way that each burst island is surrounded by the separating portion. With respect to the servo bursts, as signals are merely 0/1 signal reversals, there is no problem in the magnetic portions and separating portion being of reverse patterns.

Next, the medium is disposed in an ion beam etching (IBE) device, and the Cr mask is patterned by means of an ion milling using Ar gas. Furthermore, a dry etching is carried out on the crystal glass substrate using chlorine gas in a reactive ion etching (RIE) device.

At this time, by changing etching conditions such as RF power, bias power, gas flow rate, and vacuum, it is possible to vary the taper angle of the pattern. For example, by carrying out a plasma etching using CF₄ gas with a bias power of 100 W at a CF₄ gas flow rate of 10 sccm, a vacuum of 0.1 Pa, and an antenna power of 200 W, a stamp with a taper angle of 90 degrees is fabricated. As opposed to this, by reducing the bias power and worsening the vacuum, stamps with taper angles varying between 55 and 89 degrees are fabricated.

In order to increase the mask resistance after transferring the concavo-convex pattern of the stamp to the UV imprint resist surface, a carbon film is formed by sputtering on the UV imprint pattern. The sputtered film is easy to deposit on the convex portions of the pattern, in comparison with inside the concave portions of the pattern. The carbon film can be formed to a thickness of 20 nm on the convex portions of the pattern, and to a thickness of 5 nm in the concave portions of the pattern.

Next, the remaining film of the UV resist in the concave portions is removed by means of a plasma etching using O₂ gas. The bias power is 20 W, with a flow rate of 10 sccm, a pressure of 0.1 Pa, and an antenna power of 100 W. It is not necessary to completely remove the mask in the concave portions, but rather, it being sufficient that the ions in the ion implantation or the halogen in the halogen exposure can be transmitted, it is sufficient that it is removed to 0 to 10 nm depending on the ion implantation and halogen exposure conditions. The taper angle of the mask at this time is the same as the taper angle of the stamp at 55 to 90 degrees.

Next, by the same procedure as in Embodiment 1, an alteration of the layered body forming the patterned mask layer 72 is carried out by means of an ion implantation, as shown in FIG. 2D. As a design value of the magnetic portions 42-m in the data recording regions, the configuration is in the shape of concentric circles, having a width of 100 nm, arranged at intervals of 150 nm.

Next, as shown in FIG. 2E, the removal of the mask layer 72 is carried out. For the removal of the mask layer 72, the carbon mask is removed in an ICP-type high density plasma etching device by etching with oxygen plasma using an O₂ gas with a flow rate of 50 sccm and a pressure of 1 Pa. No bias power is applied to the layered body at this time. By means of the above process, it is possible to carry out the stripping of the mask layer 72 while minimizing damage to the magnetic portions 42-m.

Next, by the same procedure as in Embodiment 1, as shown in FIG. 2F, the protective layer 50, with a film thickness of 3 nm, made from carbon is formed using a sputtering method, and finally, perfluoro polyether is applied using a dip-coating method, forming the lubrication layer 60 with a film thickness of 2 nm, and the magnetic recording medium is obtained.

Physical irregularities in the magnetic recording medium obtained as described above are evaluated using an AFM. As a result, in the same way as in Embodiment 1, the maximum size of the concavities and convexitiea in the surface arising from the pattern of the magnetic portions 42-m and separating portion 42-s is 0.5 nm. These concavities and convexities satisfy the criterion of 2 nm or less demanded of a magnetic recording medium from the point of view of head levitation stability, and the like. Furthermore, head levitation tests are carried out using a commercially available perpendicular magnetic recording head. Contact of the head with the medium when using the magnetic recording medium obtained is of the same extent as for a normal magnetic recording medium. From this, it is found that, despite the fact that a flattening process is not applied, the magnetic recording medium of the invention exhibits excellent head levitation stability.

Furthermore, by the same procedure as in Embodiment 1, the ratio (duty) between track signal characteristics and track gaps, and fringe resistance, in the magnetic recording medium obtained are evaluated. Results of an evaluation of the relationship between the shape (taper angle) of the mask layer 72 and the discrete track medium characteristics are shown in Table 3.

TABLE 3

| Taper | Duty | Fringe Test | |
|---|---|---|---|
| Angle (°) | (%) | Change Rate (%) | Determination |
| 90 | 63 | 86 | x |
| 89 | 64 | 94 | x |
| 88 | 66 | 100 (no change) | ∘ |
| 86 | 66 | 100 (no change) | ∘ |
| 83 | 66 | 100 (no change) | ∘ |
| 79 | 66 | 100 (no change) | ∘ |
| 75 | 66 | 100 (no change) | ∘ |
| 70 | 66 | 100 (no change) | ∘ |
| 66 | 66 | 100 (no change) | ∘ |
| 60 | 63 | 89 | x |
| 55 | 57 | 81 | x |

As a result of this, it is found that, when the taper angle of the opening portions or stepped portion of the patterned portion of the mask layer 72 is 66° or more, 88° or less, there is no deterioration of the duty or fringe resistance. Because of this, it is confirmed that, in the magnetic recording medium of this embodiment too, adjacent tracks are magnetically separated.

### Embodiment 3

Next, a description will be given of another embodiment of the invention. In Embodiments 1 and 2, demagnetization is carried out by means of an ion implantation, but in this Embodiment 3, the same advantage is also obtained by exposure in an active reactive gas using CF₄ gas, using a reactive ion etching (RIE) method.

The RIE is carried out using an inductive coupled plasma (ICP) type high density plasma etching device. The plasma generating power of the high density plasma etching device is 300 W at 13.56 MHz, and the bias power is 0 W. Also, the gas flow rate is set at 50 sccm, and the gas pressure at 1 Pa.

By so doing, the magnetic recording layer 42 formed of the magnetic portions 42-m, which are portions covered by the resist in which the original magnetic characteristics still remain, and the separating portion 42-s with altered magnetic characteristics in which the magnetic recording layer is exposed by removing the resist, is fabricated.

It being sufficient that the kind of gas used is a gas including halogen, it may be, other than CF₄ gas, a gas such as CHF₃, CH₂F₂, C₃F₈, C₄F₈, SF₆, or Cl₂. It is necessary that the plasma generating power, while being appropriate for the halogen gas to radically react, causes as little physical etching as possible on the exposed surface of the magnetic recording layer. Although there is a correlation with the exposure time, the power is, for example, 100 to 500 W, and more preferably 200 to 400 W. As it is necessary that as little physical etching as possible is caused on the exposed surface of the magnetic recording layer, it is preferable that the bias power is 0 to 100 W. It being sufficient that the gas pressure is in a range such that a radical reaction proceeds, it is sufficient that it is 0.1 to 3 Pa.

### Embodiment 4

Furthermore, a description will be given of another embodiment of the invention. In Embodiment 1, a varying of the taper shape of the mask is carried out by changing the settling time in a room temperature imprinting using an SOG resist, but in this Embodiment 4, a varying of the taper shape of the mask is carried out by performing a thermal treatment after imprinting in a thermal imprinting using a thermoplastic resin. Also, the layered body shown in FIG. 2A, with the same structure as that of Embodiment 1, is used.

Next, as shown in FIG. 2B, the mask layer 70 is formed. A two layer mask of carbon and a thermoplastic resin is used for the mask layer 70. Firstly, 3 nm of diamond-like-carbon (DLC) is formed on the magnetic recording layer 40 using a CVD method. After that, 80 nm of a PMMA system thermoplastic resin is formed on the DLC using a spin-coating method.

Next, as shown in FIG. 2C, a pattern is formed on the mask layer 70. That is, a pattern formed of concavities and convexities with a pattern height of 80 nm is formed in the surface of the thermoplastic resin by a nano imprinting using an Ni stamp on the surface of the thermoplastic resin. In order to do this, the patterned surface of the Ni stamp is superimposed on the thermoplastic resin surface, they are set in a die set configured of parallel plates and, using a hydraulic press, pressed together for 30 seconds at a pressure of 10 MPa, at a temperature of 180° C., 20° C. higher than 160° C., which is the glass transition temperature of the thermoplastic resin. Subsequently, after cooling to 140° C., 20° C. lower than the glass transition temperature, the stamp and substrate are detached, and the concavo-convex pattern of the stamp is transferred to the thermoplastic resin surface.

The Ni stamp is fabricated using the same method as in Embodiment 1. An Ni stamp is fabricated wherein the pattern in the data recording regions is such that lines of width 50 nm, in the shape of concentric circles, are arranged at intervals of 150 nm.

The fabrication of the taper angle of the opening portions or stepped portion of the patterned portion of the mask layer 72 is carried out by a thermal treatment of the thermoplastic resin after imprinting the thermoplastic resin. The thermal treatment is carried out by placing the thermoplastic resin for three minutes on a hot plate heated to various setting temperatures. The thermoplastic resin used is one with a glass transition temperature of 160° C. Also, the concavo-convex shape of the mask layer 72 is evaluated with a cross-sectional SEM. From a cross-sectional SEM photograph taken at a magnification of 100,000 times, the angle of the wall surface with respect to the pattern head portion at the halfway point of the pattern height H is taken to be the taper angle θ (refer to FIG. 4). The results of evaluating the relationship between the thermal treatment temperature and the mask shape (the taper angle) are shown in Table 4.

TABLE 4

| Thermal Treatment | Taper |
|---|---|
| Temperature | Angle (°) |
| 100° C. | 90 |
| 105° C. | 89 |
| 110° C. | 88 |
| 120° C. | 86 |
| 140° C. | 83 |
| 160° C. | 79 |
| 180° C. | 75 |
| 190° C. | 70 |
| 210° C. | 66 |
| 215° C. | 60 |
| 220° C. | 55 |

Next, in order to increase the mask resistance, a carbon film is formed by sputtering on the pattern of the thermoplastic resin. The carbon sputtering is carried out in the same way as in Embodiment 2, and is such that, more being deposited on the convex portions of the pattern than inside the concave portions of the pattern, a film of a thickness of 20 nm on the convex portions of the pattern, and a thickness of 5 nm in the concave portions of the pattern, can be formed.

Next, the carbon in the concave portions and the remaining thermoplastic resin film are removed by means of a plasma etching using O₂ gas. The bias power is 20 W at a flow rate of 10 sccm, a pressure of 0.1 Pa, and an antenna power of 100 W.

It is not necessary to completely remove the mask in the concave portions, but rather, it being sufficient that the ions in the ion implantation or the halogen in the halogen exposure can be transmitted, it is sufficient that it is removed to 0 to 10 nm depending on the ion implantation and halogen exposure conditions.

Next, by the same procedure as in Embodiment 2, an alteration of the layered body forming the patterned mask layer 72 is carried out by means of an ion implantation, as shown in FIG. 2D. Next, as shown in FIG. 2E, the removal of the mask layer 72 is carried out. Furthermore, as shown in FIG. 2F, the protective layer 50 is formed, and finally, the lubrication layer 60 with a film thickness of 2 nm is formed, thus obtaining the magnetic recording medium.

Physical concavities and convexities in the magnetic recording medium obtained as described above are evaluated with an AFM. As a result, in the same way as in Embodiment 2, the maximum size of the concavities and convexities in the surface arising from the pattern of the magnetic portions 42-m and separating portion 42-s is 0.5 nm. These concavities and convexities satisfy the criterion of 2 nm or less demanded of a magnetic recording medium from the point of view of head levitation stability, and the like. Furthermore, head levitation tests are carried out using a commercially available perpendicular magnetic recording head. Contact of the head with the medium when using the magnetic recording medium obtained is of the same extent as for a normal magnetic recording medium. From this, it is found that, despite the fact that a flattening process is not applied, the magnetic recording medium of the invention exhibits excellent head levitation stability.

Furthermore, by the same procedure as in Embodiment 2, the ratio (duty) between track signal characteristics and track gaps, and fringe resistance, in the magnetic recording medium obtained are evaluated. Results of an evaluation of the relationship between the shape (taper angle) of the mask layer 72 and the discrete track medium characteristics are shown in Table 5.

TABLE 5

| Taper | Duty | Fringe Test | |
|---|---|---|---|
| Angle (°) | (%) | Change Rate (%) | Determination |
| 90 | 62 | 85 | x |
| 89 | 63 | 93 | x |
| 88 | 66 | 100 (no change) | ∘ |
| 86 | 66 | 100 (no change) | ∘ |
| 83 | 66 | 100 (no change) | ∘ |
| 79 | 66 | 100 (no change) | ∘ |
| 75 | 66 | 100 (no change) | ∘ |
| 70 | 66 | 100 (no change) | ∘ |
| 66 | 66 | 100 (no change) | ∘ |
| 60 | 63 | 89 | x |
| 55 | 57 | 81 | x |

As a result of this, it is found that, when the taper angle of the opening portions or stepped portion of the patterned portion of the mask layer 72 is 66° or more, 88° or less, there is no deterioration of the duty or fringe resistance. Because of this, it is confirmed that, in the magnetic recording medium of this embodiment too, adjacent tracks are magnetically separated.

What is claimed is:

1. A method of manufacturing a magnetic recording medium, comprising:
forming a continuous magnetic recording layer on a non-magnetic substrate;
forming a mask layer by applying a resist material on the magnetic recording layer;
forming alternating concave and convex portions in the mask layer, having step portions marking boundaries between the convex and concave portions each with a taper angle between 66 degrees and 88 degrees; and
after said forming concave and convex portions, altering magnetic characteristics of portions of the magnetic recording layer corresponding to the concave portions by ion implantation, or by exposure to an activated halogen-containing reactive gas, via the mask layer, so as to form a separating portion magnetically separating magnetic portions of the magnetic recording layer located at positions corresponding to the convex portions of the mask layer.

2. The magnetic recording medium manufacturing method according to claim 1, wherein
the resist material is an organic spin-on-glass (SOG) resist including a siloxane resin, and
said forming concave and convex portions includes forming the taper angle between 66 degrees and 88 degrees, by allowing the resist material to settle for a period of time in the range of 10 minutes to 24 hours between said forming concave and convex portions and said altering.

3. The magnetic recording medium manufacturing method according to claim 1, wherein
the resist material is an imprint resist including a thermoplastic resin and,
said forming concave and convex portions includes forming the taper angle between 66 degrees and 88 degrees, by performing a thermal treatment at a temperature within a range of 50° C. less or 50° C. higher than the glass transition temperature of the thermoplastic resin after said forming concave and convex portions.

4. A method of manufacturing a magnetic recording medium, comprising:
forming a continuous magnetic recording layer on a non-magnetic substrate;
forming a mask layer by applying an ultraviolet-cured resist material on the magnetic recording layer;
forming alternating mask concave and mask convex portions in the mask layer, the mask layer having step portions marking boundaries between the alternating mask concave and convex portions, each with a taper angle between 66 degrees and 88 degrees, by applying a crystal glass stamp, the stamp having alternating stamp concave and convex portions corresponding to the alternating mask concave and convex portions and having stamp step portions marking boundaries between the alternating step convex and concave portions, each with a taper angle between 66 degrees and 88 degrees; and
altering the magnetic characteristics of portions of the magnetic recording layer corresponding to the mask concave portions by ion implantation, or by exposure to an activated halogen-containing reactive gas, via the mask concave and convex portions, so as to form a separating portion magnetically separating magnetic portions of the magnetic recording layer in positions corresponding to the mask convex portions.
